(19) United States
(12) Patent Application Publication
(10) Pub. No.: US 2008/0112299 A1
(43) Pub. Date: May 15, 2008

(54) Magnetic disk drive

(75) Inventors: Toshihiko Shimizu, Ibaraki (JP); Keiko Watanabe, Ibaraki (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Inc., Amsterdam (NL)

(21) Appl. No.: 11/985,123

(22) Filed: Nov. 13, 2007

(30) Foreign Application Priority Data
Nov. 15, 2006 (JP) 2006-309347

(51) Int. Cl. G11B 33/02

(52) U.S. Cl. 369/75.11

(57) ABSTRACT

Embodiments of present invention help to realize a highly reliable magnetic disk drive by preventing a positional displacement between a magnetic head and a target track by decreasing restricting forces that a cover exerts on a base when the temperature is increased. According to one embodiment, a base is formed by aluminum die casting, has a concave, rectangular parallelepiped shape, and is formed with step portions at the four corners. A cover is a flat plate of stainless steel or iron. Four corner portions of the cover are bent to form step portions. The cover is fixed to the base at the four corners with bolts at two side positions (six positions in total). A gasket is inserted at that time to enhance the sealing performance. Since the gasket is a member like a rubber packing, it is necessary to press the gasket with the flat portions of the base and the cover To this end, the gasket is placed on top of the base step portions and the connection between the cover and the base at the four corners is made under the base step portions.

### CROSS-REFERENCE TO RELATED APPLICATION

The instant nonprovisional patent application claims priority to Japanese Patent Application No. 2006-309347 filed Nov. 15, 2006 and which is incorporated by reference in its entirety herein for all purposes.

### BACKGROUND OF THE INVENTION

In general, as described in Japanese Patent Publication No. 2004-5783 (“Patent document 1”) and Japanese Patent Publication No. 2006-79745 (“Patent document 2”), magnetic disk drives may be constructed in the following manner. A spindle motor for rotating magnetic disks which are supported by a rotary shaft and suspensions which hold magnetic heads for recording and reproducing magnetic information on and from the magnetic disks are supported by a lunch-box-shaped (i.e., concave) base. An access mechanism for moving each magnetic head in the radial direction of the magnetic disk via the suspension and positioning it is put in the base. The opening of the base is covered with a flat-plate-like cover, and the cover is fixed to the side wall of the base with bolts at the four corners and side positions. A tightly closed case is thus formed.

Magnetic disk drives are typically used as external storage devices of computer systems, and their uses are expanding to audio-visual (AV) apparatuses such as image data recording apparatus. As such, magnetic disk drives are now required to be increased in recording density and capacity. To increase the recording density and the capacity, the linear recording density is increased by shortening the distance between each magnetic head and the associated magnetic disk, that is, the flying amount of each magnetic head and, at the same time, the track density is increased by narrowing the recording track width of the magnetic disks.

In current magnetic disk drives, from the viewpoints of workability and cost, the base is usually formed by aluminum die casting. Particularly in stationary magnetic disk drives to secure necessary levels of silence and rigidity, the cover is usually made of stainless steel or iron. Particularly in recent years, since magnetic disk drives have come to be used more often in AV apparatus, higher levels of silence and rigidity have come to be required. As a result, stainless steel and iron are now becoming mainstream materials of the cover.

Since the linear coefficient of thermal expansion of aluminum is larger than that of each of stainless steel and iron, forces occur in the contact portions where the cover is fixed to the base when the temperature is varied. For example, when the temperature is increased, the amount of elongation of the aluminum base is larger than that of the cover made of stainless steel or iron. Therefore, resulting deformation is such that the cover restricts the elongation of the base. As a result, forces of restricting the elongation of the base occur at the base-cover connecting portions. Such forces of restricting the deformation of the base will be hereinafter referred to as “restricting forces occurring at the time of temperature variation.”

There are few problems as long as the restricting forces occurring at the time of temperature variation are weaker than the fastening forces of the bolts which fix the cover to the base. However, if restricting force is stronger than the corresponding fastening force, a slight displacement occurs at the fastening portion. At this time, the temperature-variation-induced strain in the base and the cover is freed instantaneously, whereby slight dislocations occur instantaneously in the access mechanism and the magnetic disks which are contained in the base.

In magnetic disk drives, a positioning control of a magnetic head with respect to a prescribed recording track on the associated magnetic disk is performed usually. Temperature-variation-induced deformation that causes no displacement at any fastening portion raises no problems. However, if a displacement occurs at a fastening portion, a positional displacement occurs instantaneously between a magnetic head and a target track and a positioning control cannot follow it. This results in problems that the read time increases in the case of reproduction and recording is performed erroneously on a track that is adjacent to a target track in the case of recording. The latter phenomenon means destruction of already recorded information.

Particularly in recent magnetic disk drives, the recording track width is very small because of increase in track density, as a result of which a positional displacement is prone to occur between a recording head and a recording track. This is becoming a very serious problem because it means reduction in the reliability of the recording and reproduction of magnetic disk drives.

### BRIEF SUMMARY OF THE INVENTION

Embodiments in accordance with the present invention realize a highly reliable magnetic disk drive by preventing a positional displacement between a magnetic head and a target track by decreasing restricting forces that a cover exerts on a base when the temperature is increased. According to the particular embodiment of FIG. 2, a base 6 is formed by aluminum die casting, has a concave, rectangular parallelepiped shape, and is formed with step portions 10 at the four corners. A cover 7 is a flat plate of stainless steel or iron. Four corner portions of the cover 7 are bent to form step portions 11. The cover 7 is fixed to the base 6 at the four corners with bolts 8 at two side positions (six positions in total). A gasket 9 is inserted at that time to enhance the sealing performance. Since the gasket 9 is a member like a rubber packing, it is necessary to press the gasket 9 with the flat portions of the base 6 and the cover 7. To this end, the gasket 9 is placed on top of the base step portions 10 and the connection between the cover 7 and the base 6 at the four corners is made under the base step portions 10.

### BRIEF DESCRIPTION OF THE DRAWINGS

FIG. 1 is a perspective view of a magnetic disk drive according to a first embodiment of the invention.

FIG. 2 is an exploded perspective view of the magnetic disk drive according to the first embodiment of the invention.

FIG. 3 is a schematic diagram of a connecting portion of a base and a cover of the magnetic disk drive according to the first embodiment of the invention.

FIG. 4 is a schematic diagram showing how the cover of the magnetic disk drive according to the first embodiment of the invention is deformed when the temperature is increased.

FIG. 5 is a schematic diagram of a connecting portion of a base and a cover of a magnetic disk drive of a comparative example.

FIG. 6 is a top view of a magnetic disk drive according to a second embodiment of the invention.

FIG. 7 is a sectional view taken along line A-A in FIG. 6.

FIG. 8 shows a result of a thermal deformation analysis which was made with an assumption that the operating temperature of a magnetic disk drive was increased by 10° C.

FIG. 9 shows forces occurring at the connecting portions of the base and the cover in the thermal deformation analysis of FIG. 8.

### DETAILED DESCRIPTION OF THE INVENTION

Embodiments of the present invention relate to a magnetic disk drive. More specifically, embodiments of the invention relate to the reliability of a magnetic disk drive at the occurrence of a temperature change amount.

Embodiments of the present invention have been made to solve the above problems, and an object of embodiments of the invention is therefore to realize a highly reliable magnetic disk drive by preventing a positional displacement between a magnetic head and a target track by decreasing restricting forces that the cover exerts on the base when the temperature is varied.

To attain the above object, embodiments of the invention provide a magnetic disk drive having a base which has a concave, rectangular parallelepiped shape and contains a magnetic recording/reproducing unit and a flat-plate-like cover which is smaller in the linear coefficient of thermal expansion than the base and fixed to an opening-side portion of the base, characterized in that corner portions of the cover that are fixed to the base with bolts or the like are lower in rigidity than the portion of the cover other than its corner portions.

More specifically, a base which has a rectangular, parallelepiped shape and is formed with step portions at the corners and a flat-plate-like cover which is formed with step portions at the corners are used. After a magnetic recording/reproducing unit is put in the base, the base is covered with the cover and the step portions of the cover are fixed to the step portions of the base under the latter. Where the cover is generally planar, the cover is deformed (expanded or contracted) like a plane is done when the temperature is varied, as a result of which strong restricting forces occur in the portions where the cover is fastened to the base. However, with the above configuration, the cover can be deformed flexibly because bending deformations occur in the step portions of the cover. The restricting forces occurring at the time of temperature variation are thus reduced. As a result, displacements are not prone to occur in the base-cover fastening portions even when the temperature is varied. A highly reliable magnetic disk drive can thus be realized.

Where each of the step portions of the cover is formed by bending a plate approximately along straight lines, bending deformations easily occur in the step portions of the cover. As a result, the restricting forces occurring at the time of temperature variation can further be reduced.

Where the plural step portions of the cover are independent of each other, bending deformations easily occur in the step portions of the cover. As a result, the restricting forces occurring at the time of temperature variation can further be reduced.

Another configuration is such that one or plural holes are formed in the vicinity of each of screw holes that are formed in the cover at the corners. In this case, the corner portions of the cover can be made lower in rigidity than the portion other than the corner portions. Therefore, when the temperature is increased, the corner portions are deformed flexibly and hence the forces of restricting the elongation of the base can be reduced.

According to embodiments of the invention, restricting forces that the cover exerts on the base when the temperature is varied can be reduced, which prevents a positional displacement between a magnetic head and a target track. As such, embodiments of the invention make it possible to realize a highly reliable magnetic disk drive.

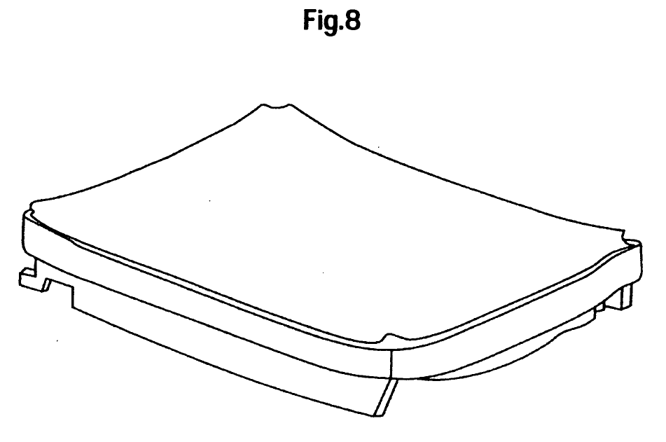

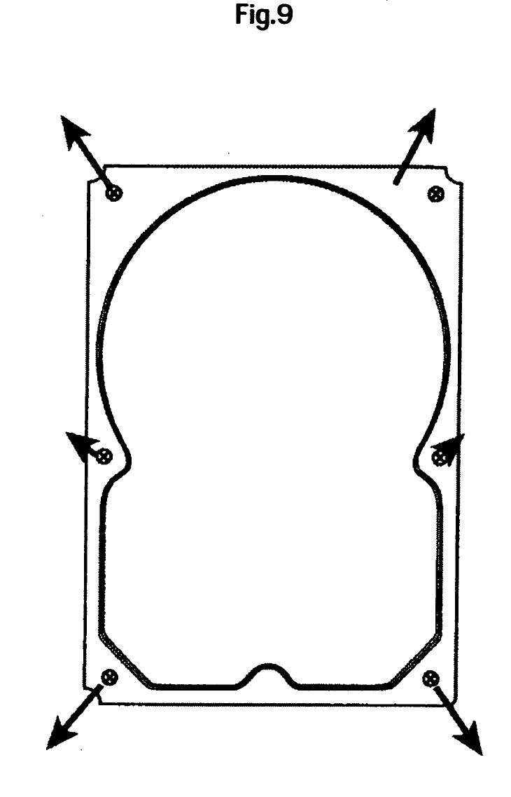

First, a description will be made of deformation of the base which is caused by the cover's restricting expansion of the base when the environment temperature of a magnetic disk drive is increased, as well as forces that occur resultingly in connecting portions of the base and the cover. FIG. 8 shows a result of a thermal deformation analysis of a magnetic disk drive in which the base is one that was formed by aluminum die casting and the cover is made of stainless steel and the cover is fixed to the base with bolts at the four corners and two side positions (six positions in total). The analysis was made with an assumption that the operating temperature was increased by 10° C. As seen from FIG. 8, deformation is such that the expansion of the base is restricted by the cover because the linear coefficient of thermal expansion of the base is larger than that of the cover. FIG. 9 shows forces occurring at the connecting portions of the base and the cover in the analysis of FIG. 8. The arrows in FIG. 9 show the directions of forces that are caused by the cover's restricting the expansion of the base, and the lengths of the arrows indicate the strengths of the forces. In particular, strong forces occur at the four corners of the base. If any of these forces becomes stronger than the friction produced by the fastening force of the bolt, the fastening portion is deviated slightly. At this time, the temperature-variation-induced strain in the base and the cover is freed instantaneously, whereby slight displacements occur instantaneously in the access mechanism and the magnetic disks which are contained in the base.

Embodiments of the invention are intended to prevent a displacement from occurring in base-cover fastening portions due to the difference between the linear coefficient of thermal expansion of the base and the cover. Magnetic disk drives according to embodiments of the invention will be hereinafter described in detail with reference to the drawings.

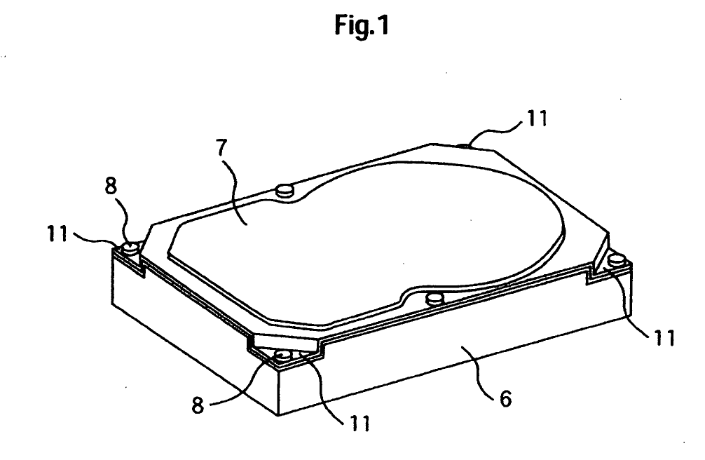

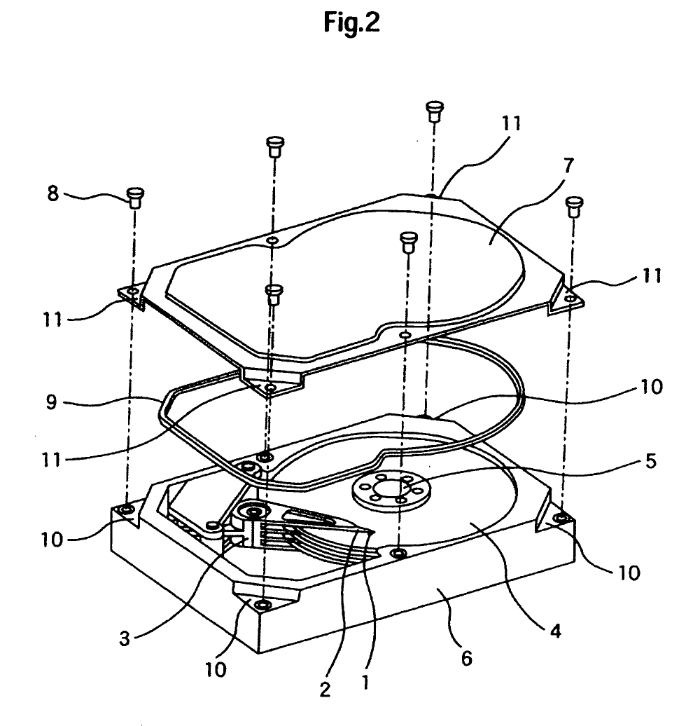

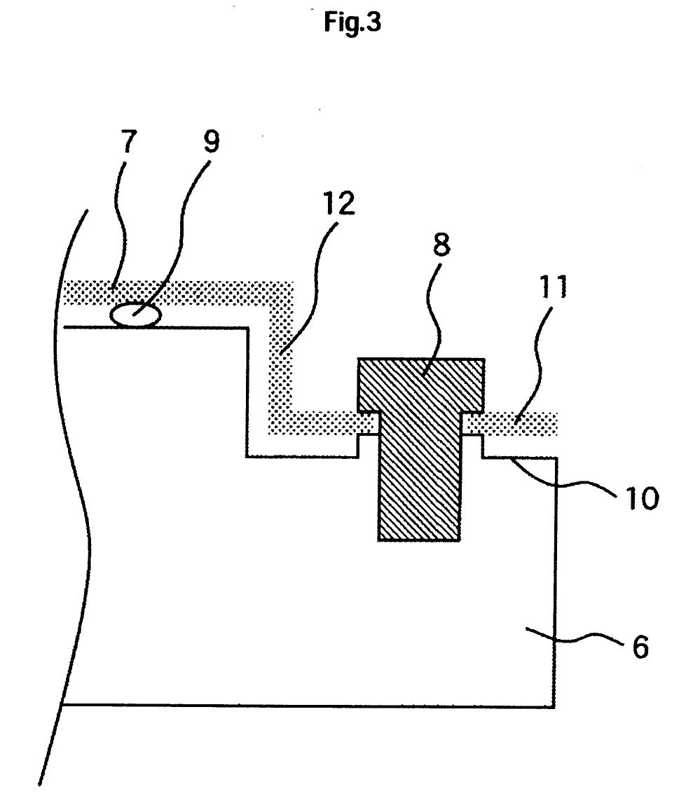

FIGS. 1 and 2 are a perspective view and a development, respectively, of a magnetic disk drive according to a first embodiment of the invention. FIG. 3 is a schematic diagram of a connecting portion of a base and a cover. As shown in FIGS. 1 and 2, a base 6 is one that was formed by aluminum die casting, has a concave, rectangular parallelepiped shape, and is formed with step portions (recesses) 10 at the four corners. The base 6 contains a spindle motor 5, magnetic disks 4 which are attached to the rotary shaft of the spindle motor 5, an access mechanism 3 which supports suspensions 2 which hold magnetic heads 1 at their tips, a head amplifier (not shown) for amplifying a recording signal to be supplied to a magnetic head 1 or a reproduction signal coming from a magnetic head, and other components. A circuit board (not shown) is attached to the back surface of the base 6, and is mounted with an LSI which incorporates a signal processing circuit, a microcontroller for controlling the entire magnetic disk drive, and other circuits.

A cover 7 is a flat plate of stainless steel or iron. Four corner portions of the cover 7 are bent at the four corners so as to form step portions 11. The step portions 11 of the cover 7 correspond to the respective step portions 10 of the base 6. To fix the cover 7 to the base 6, the step portions 11 of the cover 7 are placed on the step portions 10 of the base 6 and the step portions 10 and 11 are fastened to each other with bolts 8 at the four corners and two side positions (six positions in total). In doing so, the sealing performance is enhanced by inserting a gasket 9. Since the gasket 9 is a member like a rubber packing, it is necessary to press the gasket 9 with the flat portions of the base 6 and the cover 7. To this end, as shown in FIG. 3, the gasket 9 is placed on top of the base step portions 10 and connection between the cover 7 and the base 6 is made at the four corners under the base step portions 10.

The base 6 having the step portions 10 can be formed by forming a mold which conforms to it or cutting away corner portions of a cast base. The cover 7 can be formed by pressing a flat plate of stainless steel or iron. The step portions 11 of the cover 7 are formed by bending each of four corner portions of a flat plate two times approximately along straight lines. More specifically, each of four corner portions of a flat plate is bent along a straight line to form a planar cover step side wall 12 and a tip portion of the cover step side wall 12 is then bent outward along a straight line.

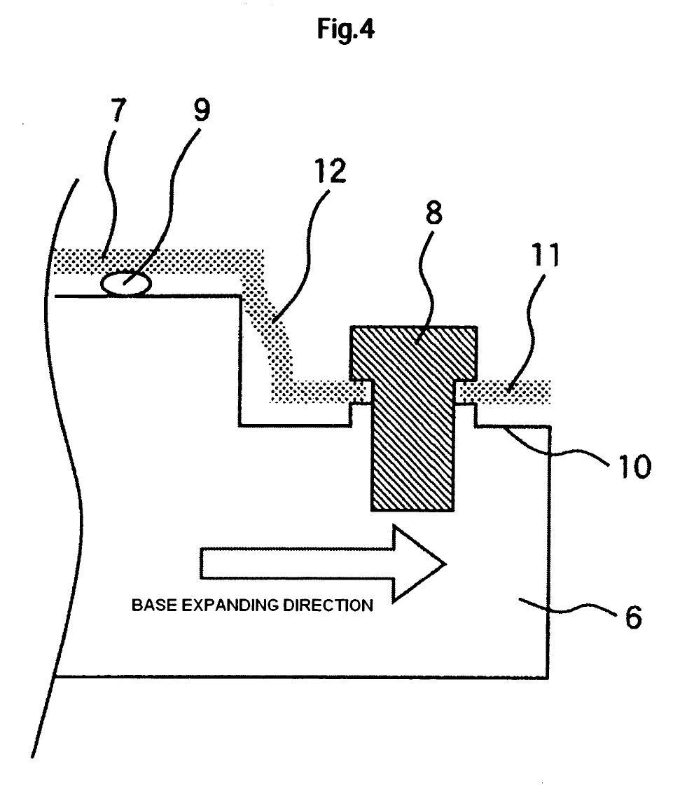

In the configuration of the embodiment shown in FIGS. 1-3, a plane bending deformation occurs in each cover step side wall 12 (see FIG. 4) when the temperature is increased. The rigidity of a plane against bending deformation is much lower than that the plane against elongation deformation. Therefore, even when the base 6 is expanded more than the cover 7 at the occurrence of a temperature increase, the cover step side walls 12 are deformed flexibly and hence the connecting portions of the cover 7 are deformed easily. And the restricting forces occurring at the time of temperature increase can be made very weak. Therefore, even with the forces of fastening the cover to the base in current magnetic disk drives, displacements can be prevented from occurring in the base-cover fastening portions. As a result, an instantaneous positional displacement between a magnetic head and a target track on the magnetic disk can be prevented. The reliability of the magnetic disk drive can thus be increased.

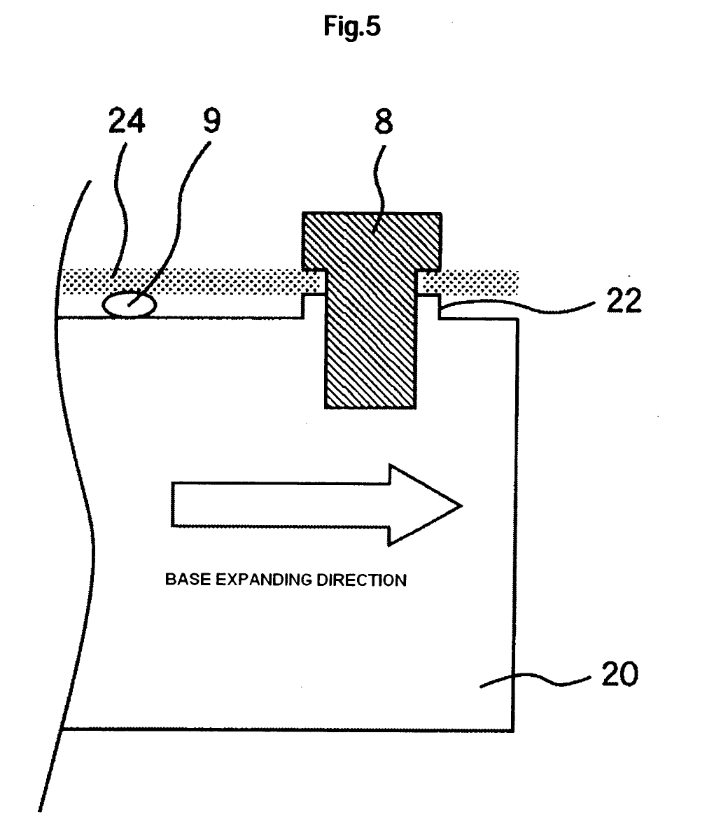

FIG. 5 is a schematic diagram of a magnetic disk drive of a comparative example in which a generally planar cover 24 is fixed to boss-shaped fixing portions 22 of a base 20 with bolts 8. As in the above embodiment, the base 20 is one which was formed by aluminum die casting and the cover 24 is made of stainless steel. When the environment temperature is increased, the base 20 is deformed more than the cover 24. Therefore, the cover 24 restricts the expansion of the base 20 (indicated by an arrow in FIG. 5) and restricting forces occur in the fastening portions of the base 20 and the cover 24. The restricting force occurring at the time of temperature increase is equal to force that is necessary for forcibly making the difference between deformations of the base 20 and the cover 24 at each connecting portion equal to zero in an imaginary restriction-free state. The restricting forces thus increase as the rigidity of the base 20 and the cover 24 becomes higher. In the configuration shown in FIG. 5, since the cover 24 is generally planar, forcibly deforming the cover 24 is equivalent to elongating the plane, which requires strong force. Even if the restricting forces occurring at the time of temperature increase are strong, no instantaneous displacements occur between the base 20 and the cover 24 as long as the fastening forces of the base 20 and the cover 24 exceed the restricting forces. The reliability of the magnetic disk drive is not lowered. However, in actual magnetic disk drives, it is difficult to increase the fastening forces to a large extent due to, for example, limitations relating to device dimensions. Where the fastening forces are increased to a certain extent, instantaneous displacements between the base 20 and the cover 24 at the occurrence of a small temperature increase can be prevented. However, in the event of a large temperature increase, strong restricting forces are freed instantaneously and hence large instantaneous displacements occur between the base 20 and the cover 24. In this manner, the reliability may be lowered contrary to the intention.

In contrast to the comparative example in which the cover is generally planar, in the embodiments of the invention, since as described above, the step portions 11 are formed by bending at the four corners of the cover 7, at the occurrence of a temperature increase the cover step side walls 12 are deformed flexibly and hence the restricting forces can be made very weak. Since the cover step side walls 12 being planar can be deformed flexibly, it is desirable that the cover step portions 11 be bent along straight lines as shown in FIGS. 1-3. Furthermore, the four cover step portion 11 shown in FIGS. 1 and 2 should be deformed outward as shown in FIG. 4 when the temperature is increased. To this end, it is desirable that the cover step side walls 12 be independent of each other. Although it is desirable that the step portions 11 of the cover 7 be provided at the four corners, the restricting forces occurring at the time of temperature variation can be reduced by providing the step portions 11 at least at three corners.

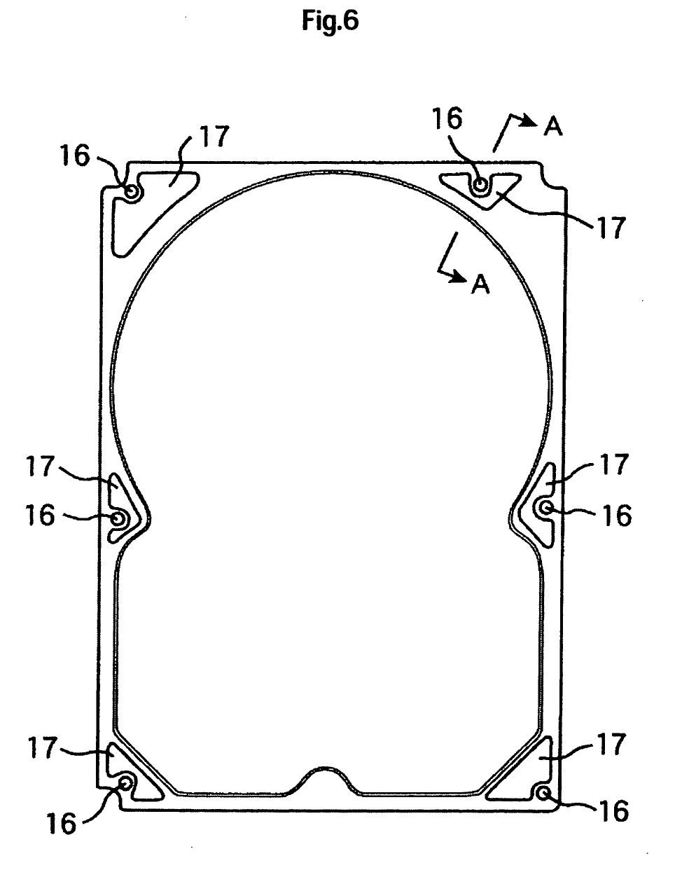

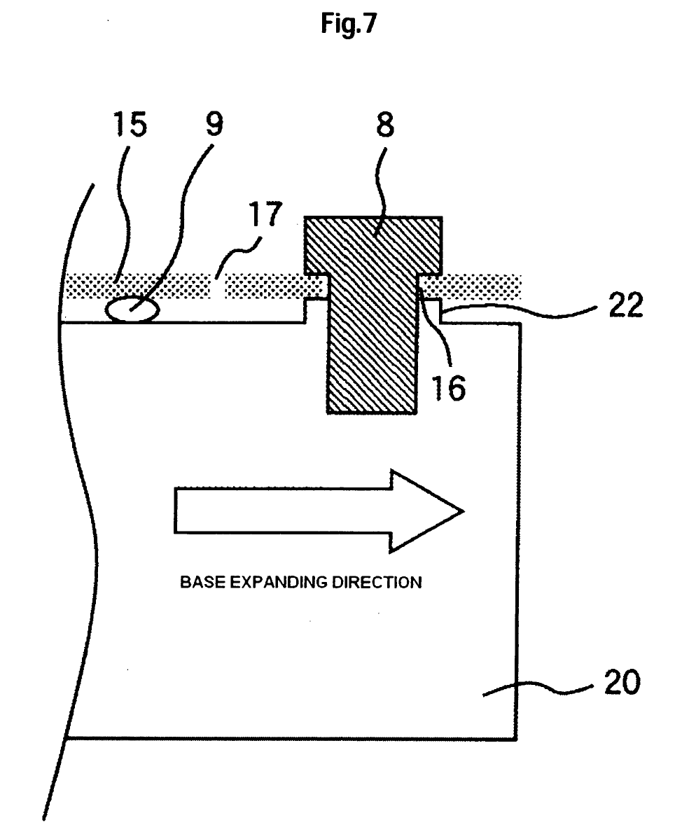

Next, a second embodiment will be described with reference to FIGS. 6 and 7. FIG. 6 is a top view of a magnetic disk drive and shows how a cover is fixed. FIG. 7 is a sectional view taken along line A-A in FIG. 6 and shows a base-cover fixing structure at one corner of a case. The base 20 may be configured in the same manner as in conventional devices and is formed with boss-shaped fixing portions 22 at the corners. The cover 15 is a flat plate of stainless steel or iron and is formed with screw holes 16 at the four corners and two side positions. Plural holes 17 are formed inside the respective screw holes 16. The holes 17 serve to make the rigidity of the corner portions of the cover 15 lower than that of the other portion (i.e., flat portion). As shown in FIG. 7, the holes 17 of the cover 15 are formed so as to be located between a gasket 9 and bolts 8 when the cover 15 is fixed to the base 20. This is to prevent dust from entering the case through the holes 17.

Also in the configuration of the second embodiment, the rigidity of the cover 15 is low at the four corners. Therefore, when the temperature is increased, the four corner portions are deformed flexibly and hence the forces of restricting the expansion of the base 20 can be made very weak. This makes it possible to prevent displacements from occurring at the fastening portions of the base 20 and the cover 15. Therefore, an instantaneous positional displacement between a magnetic head and a target track on the magnetic disk can be prevented. The reliability of the magnetic disk drive can thus be increased.

Although in the second embodiment the holes 17 are formed in the cover 15 at the four corners, the invention is not limited to such a case. The effect of reducing the restricting forces occurring at the time of temperature variation can be attained by forming the holes 17 at least at three corners.

What is claimed is:

1. A magnetic disk drive in which a spindle motor, a magnetic disk attached to a rotary shaft of the spindle motor, and an access mechanism which supports a suspension which holds the magnetic head at a tip are contained in a base having a concave, rectangular parallelepiped shape and a flat-plate-like cover having a smaller linear coefficient of thermal expansion than the base is fixed to an opening-side portion of the base, characterized in that:
the base has step portions at least at three corners, the cover has step portions at corners corresponding to the at least three corners of the base, and the step portions of the cover are placed on the step portions of the base and fixed to the step portions of the base under the latter.

2. The magnetic disk drive according to claim 1, characterized in that the step portions of the base are recesses.

3. The magnetic disk drive according to claim 1, characterized in that each of the step portions of the cover has a planar side wall.

4. The magnetic disk drive according to claim 1, characterized in that each of the step portions of the cover is formed by bending a corner portion two times approximately along straight lines.

5. The magnetic disk drive according to claim 1, characterized in that each of the step portions of the cover is formed by bending a corner portion toward the base approximately along a straight line and then bending the corner portion outward approximately along a straight line.

6. The magnetic disk drive according to claim 1, characterized in that the step portions of the cover are independent of each other.

7. The magnetic disk drive according to claim 1, characterized in that the base is formed by aluminum die casting and the cover is made of stainless steel or iron.

8. The magnetic disk drive according to claim 1, characterized in that a gasket is provided between contact surfaces of the base and the cover.

9. The magnetic disk drive according to claim 1, characterized in that the cover is fixed to the base with bolts at least four positions including the corners.

10. A magnetic disk drive in which a spindle motor, a magnetic disk attached to a rotary shaft of the spindle motor, and an access mechanism which supports a suspension which holds the magnetic head at a tip are contained in a base having a concave, rectangular parallelepiped shape and a flat-plate-like cover having a smaller linear coefficient of thermal expansion than the base is fixed to an opening-side portion of the base, characterized in that:
the base has step portions at four corners, the cover has step portions at the four corners, and the step portions of the cover are placed on the step portions of the base and fixed to the step portions of the base under the latter.

11. The magnetic disk drive according to claim 10, characterized in that each of the step portions of the cover has a planar side wall.

12. The magnetic disk drive according to claim 10, characterized in that the step portions of the base are recesses, and the step portions of the cover are bent so as to conform to the step portions of the base.

13. The magnetic disk drive according to claim 10, characterized in that the step portions of the cover are independent of each other.

14. The magnetic disk drive according to claim 10, characterized in that a gasket is provided between contact surfaces of the base and the cover.

15. The magnetic disk drive according to claim 10, characterized in that the cover is fixed to the base with bolts in at least four positions including the four corners.

16. A magnetic disk drive in which a spindle motor, a magnetic disk attached to a rotary shaft of the spindle motor, and an access mechanism which supports a suspension which holds the magnetic head at a tip are contained in a base having a concave, rectangular parallelepiped shape and a flat-plate-like cover having a smaller linear coefficient of thermal expansion than the base is fixed to an opening-side portion of the base via a gasket at least at corners, characterized in that:
at least three of corner portions of the cover is lower in rigidity than the portion other than the corner portions.

17. The magnetic disk drive according to claim 16, characterized in that the cover is formed with holes inside at least three of portions that are fixed to the base.

18. The magnetic disk drive according to claim 16, characterized in that the cover is formed with holes between the gasket and at least three of portions that are fixed to the base.
